(19) United States
(12) Patent Application Publication
(10) Pub. No.: US 2024/0295666 A1
(43) Pub. Date: Sep. 5, 2024

(54) JOINT PRECONDITIONING FOR TIME-LAPSE FULL WAVEFORM INVERSION METHOD AND SYSTEM

(71) Applicant: CGG SERVICES SAS, Massy Cedex (FR)

(72) Inventors: Filipe RUDRIGUES, Niteroi (BR); Danilo ALBUQUERQUE, Rio de Janeiro (BR); Gabriel BRANDO, Rio de Janeiro (BR); Danilo FROES, Rio de Janeiro (BR); Benjamin HUARD, Rio de Janeiro (BR); Luis CYPRIANO, Rio de Janeiro (BR); Roberto PEREIRA, Rio de Janeiro (BR); Adel KHALIL, Rio de Janeiro (BR)

(21) Appl. No.: 18/630,066

(22) Filed: Apr. 9, 2024

Related U.S. Application Data
(60) Provisional application No. 63/627,126, filed on Jan. 31, 2024.

(51) Int. Cl. G01V 1/30; G01V 1/36

(52) U.S. Cl. CPC G01V 1/308; G01V 1/303; G01V 1/306; G01V 1/364; G01V 2210/612; G01V 2210/614

(57) ABSTRACT

A joint timelapse full waveform inversion (FWI) method for estimating physical properties of a subsurface includes receiving seismic data related to the subsurface, wherein the seismic data includes a baseline dataset d_{B} and a monitor dataset d_{M}, defining an objective function of the FWI method, calculating a baseline gradient g_{B} of the objective function for the baseline dataset d_{B}, and a monitor gradient g_{M} of the objective function for the monitor dataset d_{M}, computing a baseline preconditioner P′_{B} for the baseline dataset d_{B} and a monitor preconditioner P′_{M} for the monitor dataset d_{M} so that each of the baseline preconditioner P′_{B} and the monitor preconditioner P′_{M} reflects similarities and/or differences of geometrical features of the baseline and monitor acquisition surveys, and determining physical properties of the subsurface based on a baseline physical properties update and a monitor physical properties update.

### BACKGROUND OF THE INVENTION

### Technical Field

Embodiments of the subject matter disclosed herein generally relate to a system and method for imaging a subsurface by calculating a model of the subsurface based on Full Waveform Inversion (FWI), and more particularly, to a joint preconditioning time-lapse FWI method that imposes geometrical effects of a first dataset into a preconditioner of a second dataset and vice-versa. The preconditioning accounts for differences in the acquisition geometry between the two datasets and compensates for them such that the resulting models highlight genuine 4D signals of the earth and reduces noise related to unrepeatability in data acquisition methods.

### Discussion of the Background

Seismic data is acquired to generate a profile (image or model of a property, such as velocity) of the geophysical structure (subsurface) under the surface. While this profile does not provide an accurate location for a desired resource (e.g., oil and gas) reservoir, it suggests, to those trained in the field, the presence or absence of the resource reservoirs. Thus, providing a high-resolution profile of the subsurface prior to drilling a well or for exploration purposes of an existing well is an ongoing process in the exploration of natural resources field.

The seismic data used for generating the image or model of the subsurface may be acquired in various ways, for example, with land equipment, marine equipment, ocean bottom equipment, autonomous underwater equipment, or aerial equipment. The type of sensors and sources used in any of these scenarios are known in the art and thus, not repeated herein. After the seismic data is acquired, it needs to be processed to eventually generate the image of the subsurface. There are many known algorithms for processing the seismic data. Migration is one such algorithm that is used for seismic data analysis. Migration allows for the correct positioning of subsurface structures and reflectivity. However, some of the existing migration methods generate images that may suffer from lack of resolution, bad event continuity and zones with dimmed amplitude, due to band-limited sources and uneven illumination patterns of seismic waves.

A particular application for migration is in time-lapse (4D) processing where images of the same underground region are obtained from two or more different datasets (vintages), e.g., baseline and monitors datasets, which are recorded at different times with acquisition systems possibly having different geometries. The 4D processing is usually employed for the purpose of reservoir monitoring (i.e., to monitor the changes in the reservoir by determining the changes between the monitors and the baseline datasets) during the oil and gas production phase. The level of the 4D signal (signal that corresponds to the differences between the baseline and monitor datasets) is usually small and can easily blend in with noise or problems related to the acquisition.

These limitations can be partially overcome by using Least-Squares Migration (LSM) method, which is a more robust inversion method based on minimizing the misfit between the observed/recorded seismic data d and the synthetic data generated by an inverted reflectivity, as discussed in [1]. However, this method is based on a linear assumption between the reflectivity and the recorded seismic data which may not be a good approximation on complex geological settings.

Another method for obtaining models of the physical properties of the subsurface, such as velocity or density, from the recorded seismic data d through a minimization problem using the full information of the wavefield is the FWI, introduced by [2-4]. Unlike LSM, it does not presuppose linearity and can thus model more physical phenomena and deal better with the complexity of the geology of the subsurface. With the advances of computing power, the FWI has increasingly become a main component for the oil and gas industry during phases of exploration and production, delivering high-resolution models with useful information for reservoir interpretation.

FWI can be applied as part of a time-lapse or 4D processing, for reservoir monitoring during the oil and gas production phase [8, 9]. The 4D processing discussed herein may be used for other applications, for example, CO2 storage [10, 11].

The small level of the 4D signal compared to the background also poses a challenge for 4D FWI as the signal can easily be masked by noise, especially when the seismic acquisitions have weak repeatability. Many strategies [12-17] have been put forward to mitigate some of the problems related to obtaining consistent FWI results between vintages. However, the existing methods generally rely on good repeatability among the acquisition geometries of the vintages and thus, there is a need for better methods that can handle the recorded seismic data (especially the 4D signal) in a more general way. Accordingly, it would be desirable to provide systems and methods with such capabilities.

### SUMMARY OF THE INVENTION

According to an embodiment, there is a joint timelapse full waveform inversion (FWI) method for estimating physical properties of a subsurface, and the method includes receiving seismic data related to the subsurface, wherein the seismic data includes a baseline dataset d_{B} and a monitor dataset d_{M}, with the monitor dataset d_{M} being acquired later in time than the baseline dataset d_{B}, for the same subsurface, defining an objective function of the FWI method, calculating, for an iteration of the FWI, a baseline gradient g_{B} of the objective function for the baseline dataset d_{B}, and a monitor gradient g_{M} of the objective function for the monitor dataset d_{M}, computing a baseline preconditioner P′_{B} for the baseline dataset d_{B} and a monitor preconditioner P′_{M} for the monitor dataset d_{M} so that each of the baseline preconditioner P′_{B} and the monitor preconditioner P′_{M} reflects similarities and/or differences of geometrical features of the baseline and monitor acquisition surveys, and determining physical properties of the subsurface based on a baseline physical properties update and a monitor physical properties update, the baseline and monitor physical properties updates being calculated based on the baseline preconditioner P′_{B}, the baseline gradient g_{B}, the monitor preconditioner P′_{M}, and the monitor gradient g_{M}.

According to another embodiment, there is a a computing device for joint preconditioning timelapse full waveform inversion (FWI) for generating an image of a subsurface, and the computing device includes an interface for receiving seismic data related to the subsurface, wherein the seismic data includes a baseline dataset d_{B} and a monitor dataset d_{M}, with the monitor dataset d_{M} being acquired later in time than the baseline dataset d_{B}, for the same subsurface; and a processor connected to the interface. The processor is configured to define an objective function of the FWI method, calculate, for an iteration of the FWI, a baseline gradient g_{B} of the objective function for the baseline dataset d_{B}, and a monitor gradient g_{M} of the objective function for the monitor dataset d_{M}, compute a baseline preconditioner P′_{B} for the baseline dataset d_{B} and a monitor preconditioner P′_{M} for the monitor dataset d_{M} SO that each of the baseline preconditioner P′_{B} and the monitor preconditioner P′_{M} reflects similarities and/or differences of geometrical features of the baseline and monitor acquisition surveys and determine physical properties of the subsurface based on a baseline physical properties update and a monitor physical properties update, the baseline and monitor physical properties updates being calculated based on the baseline preconditioner P′_{B}, the baseline gradient g_{B}, the monitor preconditioner P′_{M}, and the monitor gradient g_{M}.

According to yet another embodiment, there is a non-transitory computer readable medium including computer executable instructions, where the instructions, when executed by a processor, implement the methods noted herein.

### BRIEF DESCRIPTION OF THE DRAWINGS

For a more complete understanding of the present invention, reference is now made to the following descriptions taken in conjunction with the accompanying drawings, in which:

FIG. 1 is a flow chart of a FWI method for generating a model of a subsurface using a cost function;

FIG. 2 is a flow chart of a method for using joint preconditioners for calculating a model update of the subsurface;

FIG. 3 schematically illustrates a geological formation located into a subsurface and how a source probes the formation with seismic waves;

FIG. 4 is a flow chart of a method for using timelapse FWI for calculating an image of a subsurface using joint preconditioning;

FIG. 5A illustrates a true baseline model below the base of a salt and

FIG. 5B illustrates a true monitor model for the same subsurface;

FIG. 6A illustrates an inverted model using traditional preconditioners,

FIG. 6B illustrates an inverted model using joint preconditioners, and FIG. 6C illustrates the difference between the models of FIGS. 6A and 6B; and

FIG. 7 is a schematic diagram of a data computing system for generating an image of the subsurface based on joint preconditioning.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a joint preconditioning for time-lapse FWI method for processing 4D seismic data for generating an image of the subsurface. However, the embodiments to be discussed next are not limited to seismic data, but may be applied to other type of data.

The methods discussed herein may be applied to the field of subsurface exploration, for example, hydrocarbon exploration and development, geothermal exploration and development, and carbon capture and sequestration, or other natural resource exploration and exploitation. They could also be employed for surveying and monitoring for windfarm applications, both onshore and offshore, and also for medical imaging applications.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Prior to discussing the joint preconditioning for time-lapse FWI, an existing generic FWI method is first discussed. As noted in the Background section, land or marine seismic surveys can be used to extract rock properties and construct reflectivity images of the subsurface. Such surveys can provide an accurate image of the subsurface structure of the portion of the earth being surveyed. The subsurface structure may be associated with mineral resources and/or hydrocarbons reservoirs. Thus, it is important to have high quality tools for processing the recorded seismic data in order to generate a high-accuracy image of the surveyed substructure. Generating the image of the subsurface is a technological process that is continuously improved by those skilled in the art. The following description continues along this line, i.e., improving the process of generating a high quality image of the subsurface.

FWI is one known method for analyzing seismic data. FWI is able to produce models in a subsurface region of physical properties such as Vp (velocity model) or ρ (density model) that have high fidelity and are well-resolved spatially. FWI, in this embodiment, seeks to extract the properties of subsurface rocks from two given seismic dataset recorded at the surface or seabed. The two seismic datasets are taken for the same subsurface, with a time delay (e.g., months or years), generally with a different acquisition setup. Sources of non-repeatability between the surveys include differences in the distance between the sensors, the distance between the sources, the distance between the sensors and the sources, the length of the streamers (for a marine survey), the firing timing of the sources, the type of sources, or the type of sensors vary from the baseline to the monitor or from a first monitor to a second monitor. This change in geometry is captured in a method later discussed.

Essentially, the FWI technique iteratively updates a two- or three-dimensional velocity (or density) model to represent the surveyed subsurface Earth model in such a way that generated estimated seismic with updated models matches the recorded seismic data.

In this example, the velocity model is used to calculate an estimate of the seismic dataset. The predicted seismic dataset is then compared to the recorded seismic dataset. Then, based on the mismatch between the two datasets, the velocity model is iteratively updated until the predicted seismic dataset matches the recorded seismic data to a sufficient degree of accuracy or until a desired degree of convergence is obtained.

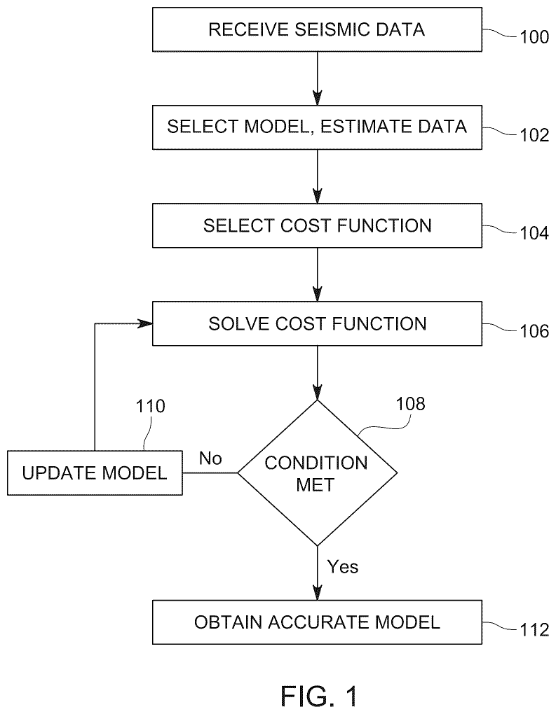

A general method of updating the velocity model with the FWI method is now described with regard to FIG. 1. FWI typically operates on the principle of iteratively updating the starting velocity model to minimize (or maximize) a cost function through repeated calculations. In step 100, recorded seismic data d is received. The recorded seismic data may be recorded on land or in a marine environment, as discussed above. It may be recorded with hydrophones, geophones, accelerometers, or any combination of these and other sensors. In step 102, a velocity model is chosen (e.g., selected from an existing library, calculated based on existing data about the surveyed subsurface, etc.) and estimated seismic data is estimated based on the current velocity model. In step 104, a cost function is defined. The cost function may be a measure of the mismatch or similarity between the recorded seismic data and the estimated seismic data. If the cost function is selected to represent the mismatch between the recorded and estimated seismic data, it may compare traces from the two sets of data, for example, by subtracting one trace from another, i.e., one trace from each set of recorded and estimated seismic data.

Due to the non-linearity in the relationship between the velocity model and the seismic data, the cost function used in FWI may have many local minima, rather than being a convex function with only one global minimum. Because of this, it is necessary to have a sufficiently accurate starting velocity model to achieve global minimum convergence. The cost function can be formulated in the frequency domain, the time domain, or any other suitable domain.

Traditionally, localized gradient-based methods are used in step 106 to minimize the cost function. These methods iteratively update the existing velocity model in a direction that derives from the cost function's direction of steepest descent. For this reason, after the cost function has been calculated in step 106, a given criterion (i.e., a predetermined condition) is checked in step 108. If the predetermined condition is not met, for example, how close the estimated data is to the recorded data, the process advances to step 110 in which the starting velocity model is updated and a new data estimate is calculated. Then, the process returns to step 106 to recalculate the cost function to further minimize it. This FWI is a local iterative inversion scheme and the process makes in step 110 a series of step-wise improvements to the model, which successively reduces the cost function toward the predetermined condition. When the condition is met in step 108, the improved model is returned to the user in step 112.

The step of minimizing the cost function is performed according to various algorithms by the exiting methods. For example, uses a parallel strategy for independently inverting the baseline and monitor datasets. According to the embodiments discussed next, this strategy is modified for jointly inverting the baseline and monitor datasets, so that differences in the acquisition geometry between the two datasets are reflected into a preconditioning approach to compensate for them such that the resulting models highlights genuine 4D signals of the earth and reduces noise related to unrepeatability in data acquisition methods.

More specifically, consider a timelapse 4D FWI cost function J. The term “timelapse” is defined in this disclosure to mean the presence of at least two datasets d_{B} and d_{M} collected at different times for a same subsurface, i.e., two datasets corresponding to two different surveys, e.g., a baseline and a monitor or two monitors). The cost function J(m_{B}, m_{M}) may be expressed in terms of a baseline model m_{B}, which is built based on the baseline seismic data d_{B}, and a monitor model m_{M}, which is built based on the monitor seismic data d_{M} as follows:

$$J ( {m}_{B} , {m}_{M} ) = {J}_{B} ( {m}_{B} ) + {J}_{M} ( {m}_{B} ) + R ( {m}_{B} , {m}_{M} ) , \qquad ( 1 )$$

where J_{B} and J_{M} are independent functions for baseline and monitor, and R is a regularization term that depends on both models. Note that the two models describe, as already discussed above, one or more parameters of the subsurface, i.e., the velocity, or density, etc.

To minimize the cost function J(m_{B}, m_{M}), the gradients (see equations (2)) and Hessians (see equations (3)) of the cost function are first calculated as follows:

$${g}_{B} = \frac{\partial J}{\partial {m}_{B}} , {g}_{M} = \frac{\partial J}{\partial {m}_{M}} , \qquad ( 2 )$$

$${H}_{B} = \frac{{\partial }^{2} J}{\partial {m}_{B}^{2}} , {H}_{M} = \frac{{\partial }^{2} J}{\partial {m}_{M}^{2}} , {H}_{BM} = {H}_{MB} = \frac{{\partial }^{2} J}{\partial {m}_{B} \partial {m}_{M}} , \qquad ( 3 )$$

and then the Newton's equations (4) are solved for finding model updates Δm_{B} and Δm_{M} for each iteration 110, where the Newton's equations are given by:

$$[ \begin{matrix}{H}_{B} & {H}_{BM} \\ {H}_{MB} & {H}_{M}\end{matrix} ] [ \begin{matrix}Δ {m}_{B} \\ Δ {m}_{M}\end{matrix} ] = - [ \begin{matrix}{g}_{B} \\ {g}_{M}\end{matrix} ] . \qquad ( 4 )$$

The gradients and Hessians in equations (2) and (3) may be calculated through the adjoint state method, as disclosed in and [19]. The inverse of the Hessian is required to be calculated to determine the model updates. Note that the model updates are calculated at each loop 110 in FIG. 1, and then they are added to the previous models m_{B} and m_{M} to calculate the updated models, which are used for the next iteration. There are many ways in the field to calculate an approximation of the inverse Hessian, for example, [7, 19, 20].

Based on any of these methods, the model updates Δm_{B} and Δm_{M} for an iteration are traditionally calculated based on:

$$Δ {m}_{B} = - {P}_{B} {g}_{B} , Δ {m}_{M} = - {P}_{M} {g}_{M} , \qquad ( 5 )$$

where a preconditioner P (one for the baseline and one for the monitor) approximately describes the inverse of the Hessian. These calculations are performed in parallel, i.e., the base preconditioner is independent of the monitor dataset and vice-versa.

In general, for seismic data, the inversion problem is ill-posed, and a true inverse does not exist, or one cannot iterate enough to the true solution. In the context of optimization algorithms, particularly gradient-based optimization methods, a preconditioner is a modification applied to the Hessian matrix or its approximation to improve the convergence rate of iterative optimization algorithms. In optimization problems, especially those with ill-conditioned or highly non-linear objective functions, the convergence of gradient-based optimization algorithms can be slow or even fail. Preconditioning aims to address this issue by transforming the optimization problem into a more favorable form that aids convergence.

A preconditioner typically takes the form of a symmetric and positive-definite matrix P that is used to transform the original optimization problem. The transformed problem is then solved using an iterative optimization algorithm, such as conjugate gradient or preconditioned conjugate gradient methods. The choice of preconditioner depends on the specific problem and characteristics of the objective function. Common preconditioners include diagonal scaling, incomplete Cholesky factorization, and approximate inverses of the Hessian matrix.

In this regard, a traditional approach [12] uses a parallel strategy, where the baseline and monitor datasets are inverted independent of each other. However, in this embodiment, a joint preconditioning is used to account for the differences in the acquisition geometry between the two datasets (baseline and monitor or two monitors) and compensates for them such that the resulting (updated) models m_{B} and m_{M} highlight genuine 4D signals of the earth and reduces noise related to unrepeatability in data acquisition methods.

More specifically, the novel joint preconditioning imposes the condition P=H⁻¹ at least along a given direction of the search space, which is representative of the current iteration of the FWI method illustrated in FIG. 1. According to this embodiment, γ is selected to be such direction, which is called the “probing gradient,” and P′ is the joint preconditioner. In the general sense, γ can be defined as a function of g_{B} and g_{M}, γ=Γ(g_{B}, g_{M}), which enforces γ to be a representative gradient for the current FWI iteration via the dependence on the gradients of the different vintages. γ can be a generalized average, which may include weights to favor one vintage over the other, and include any processing deemed necessary, e.g., denoise. To compute the joint preconditioner, this embodiment imposes the following condition:

$${P}_{B}^{′} {H}_{B} γ = {P}_{M}^{′} {H}_{M} γ . \qquad ( 6 )$$

Based on this condition, the new preconditioners P′_{B} and P′_{M} can be determined in terms of the original preconditioners P′_{B} and P′_{M} from equation (5) and the reference direction γ. Different acquisition geometries probe the subsurface in different ways, and this is reflected in the Hessian operator. Thus, the novel constraint (6) imposes the geometrical effects (or features) of the monitor acquisition into the baseline preconditioner, and vice-versa. In particular, the null-space of the monitor Hessian is inherited by the baseline preconditioner, and vice-versa. Thus, in one implementation, it is desirable to choose the probing gradient γ to cover what both vintages can probe. For example, in one case, the probing gradient γ is selected to be an average of both gradients g_{B} and g_{M} in equation (5).

The joint preconditioners P′_{B} and P′_{M} can be calculated as now discussed. A transform [symbol] from the gradient space to a filter space, for example, Fourier, wavelet, curvelet, etc. is selected. Based on the transform [symbol] , the preconditioners can be computed through filters s_{B} and s_{M}:

$${P}_{B}^{′} {g}_{B} = {ℱ}^{- 1} ( {s}_{B} ℱ ( {g}_{B} ) ) , {P}_{M}^{′} {g}_{M} = {ℱ}^{- 1} ( {s}_{M} ℱ ( {g}_{M} ) ) . \qquad ( 7 )$$

Note that equation (7) takes the gradient from the gradient space and transforms it into the filter space, for example, the wavelet space. Then, the corresponding filter s acts on the transformed gradient, and finally an inverse transform [symbol] ⁻¹ is applied to bring the filtered transformed gradient back to the gradient space, as the quantity P′ₓgₓ, with x being B or M depending on the situation.

The general transformation [symbol] , which is a linear transform, is named herein a “filter transform” because the filter is calculated in this domain. One usual choice for this transform is the curvelet transform [21], which is a mathematical technique used in seismic imaging, and image processing in general, where data is often characterized by curves and edges at various scales and orientations. It is an extension of the wavelet transform, designed to capture highly directional and anisotropic features in data. In the context of seismic imaging, the curvelet transform is employed to analyze seismic data in a way that efficiently represents features of subsurface structures. Seismic data often contains information about subsurface layers, faults, and other geological features that have different orientations and scales. The curvelet transform excels at capturing these features by using a multiscale and multidirectional decomposition approach.

Other transforms may be used, for example, Fourier, ridgelet, contourlet, seislet, linear Radon, parabolic Radon, hyperbolic Radon, shifted-hyperbolic Radon, wavelet, complex wavelet, etc., some of which are described in Yilmaz, Öz (2001), “Seismic data analysis,” Society of Exploration Geophysicists, ISBN 1-56080-094-1.

The filters s may be found by minimizing a cost function in the filter space, [symbol] , which is defined in this embodiment as:

$$𝒞 = {‖ {s}_{B} ℱ ( {g}_{B} ) - ℱ ( {P}_{B} {g}_{B} ) ‖}^{2} + {ε}_{B}^{2} {‖ {s}_{B} ‖}^{2} + {‖ {s}_{M} ℱ ( {g}_{M} ) - ℱ ( {P}_{M} {g}_{M} ) ‖}^{2} + {ε}_{M}^{2} {‖ {s}_{M} ‖}^{2} + ( 〈 λ , {s}_{B} ℱ ( {H}_{B} γ ) - {s}_{M} ℱ ( {H}_{M} γ ) 〉 + c . c . ) , \qquad ( 8 )$$

where ε_{B} and ε_{M} are regularization terms and c.c. is the complex conjugate of the term inside the brackets.

The first four terms in equation (8) are the independent minimization of the baseline and monitor filters, including the independent regularization terms. The fifth term in equation (8) is coupling the constraint of equation (6) imposed by the Lagrange multiplier λ. The solution to equation (8) is given by:

$${s}_{B} = \qquad ( 9 )$$

$$\frac{{ℱ ( {g}_{B} )}^{*} ℱ ( {P}_{G} {g}_{B} ) {\vert ℱ ( {H}_{M} γ ) \vert}^{2} + {ℱ ( {g}_{M} )}^{*} ℱ ( {P}_{M} {g}_{M} ) {ℱ ( {H}_{B} γ )}^{*} ℱ ( {H}_{M} γ )}{{\vert ℱ ( {H}_{M} γ ) \vert}^{2} ( {\vert ℱ ( {g}_{B} ) \vert}^{2} + {ε}_{B}^{2} ) + {\vert ℱ ( {H}_{B} γ ) \vert}^{2} ( {\vert ℱ ( {g}_{M} ) \vert}^{2} + {ε}_{M}^{2} )} ,$$

$${s}_{M} = \frac{{ℱ ( {g}_{M} )}^{*} ℱ ( {P}_{M} {g}_{M} ) {\vert ℱ ( {H}_{B} γ ) \vert}^{2} + {ℱ ( {g}_{B} )}^{*} ℱ ( {P}_{B} {g}_{B} ) {ℱ ( {H}_{M} γ )}^{*} ℱ ( {H}_{B} γ )}{{\vert ℱ ( {H}_{M} γ ) \vert}^{2} ( {\vert ℱ ( {g}_{B} ) \vert}^{2} + {ε}_{B}^{2} ) + {\vert ℱ ( {H}_{B} γ ) \vert}^{2} ( {\vert ℱ ( {g}_{M} ) \vert}^{2} + {ε}_{M}^{2} )} .$$

The unconstrained solutions for the filters s_{B} and s_{M}, here noted by the superscript 0, are obtained by minimizing the cost function [symbol] while keeping the Lagrange multiplier λ=0, and are given by:

$${s}_{B}^{0} = \frac{{ℱ ( {g}_{B} )}^{*} ℱ ( {P}_{B} {g}_{B} )}{{\vert ℱ ( {g}_{B} ) \vert}^{2} + {ε}_{B}^{2}} , {s}_{M}^{0} = \frac{{ℱ ( {g}_{M} )}^{*} ℱ ( {P}_{M} {g}_{M} )}{{\vert ℱ ( {g}_{M} ) \vert}^{2} + {ε}_{M}^{2}} . \qquad ( 10 )$$

The constrained solutions satisfy the following identity:

$$\begin{matrix}{s}_{B} ℱ ( {H}_{B} γ ) = \frac{\begin{matrix}{s}_{B}^{0} ℱ ( {H}_{B} γ ) {\vert ℱ ( {H}_{M} γ ) \vert}^{2} ( {\vert ℱ ( {g}_{B} ) \vert}^{2} + {ε}_{B}^{2} ) + \\ {s}_{M}^{0} ℱ ( {H}_{M} γ ) {\vert ℱ ( {H}_{B} γ ) \vert}^{2} ( {\vert ℱ ( {g}_{M} ) \vert}^{2} + {ε}_{M}^{2} )\end{matrix}}{\begin{matrix}{\vert ℱ ( {H}_{M} γ ) \vert}^{2} ( {\vert ℱ ( {g}_{B} ) \vert}^{2} + {ε}_{B}^{2} ) + \\ {\vert ℱ ( {H}_{B} γ ) \vert}^{2} ( {\vert ℱ ( {g}_{M} ) \vert}^{2} + {ε}_{M}^{2} )\end{matrix}} \\ = {s}_{M} ℱ ( {H}_{M} γ )\end{matrix} \qquad ( 11 )$$

where the constrained s_{B} [symbol] (H_{B}γ) and s_{M} [symbol] (H_{M}γ) are a weighted average of the unconstrained s_{B}⁰ [symbol] (H_{B}γ) and s_{M}⁰ [symbol] (H_{M}γ). The results can be generalized using any generalized mean, for example, the Lehmer mean Lₚ:

$${s}_{B} ℱ ( {H}_{B} γ ) = {L}_{p} ( {s}_{B}^{0} ℱ ( {H}_{B} γ ) , {s}_{M}^{0} ℱ ( {H}_{M} γ ) ) = {s}_{M} ℱ ( {H}_{M} γ ) . \qquad ( 12 )$$

The two filters s_{B} and s_{M} obtained in equations (11) or (12) are then used in equations (7) to calculate the joint preconditioners P′_{B} and P′_{M} and the joint preconditioners are used in equations (13) for calculating the model improvements Δm_{B} and Δm_{M}:

$$Δ {m}_{B} = - {P}_{B}^{′} {g}_{B} , Δ {m}_{M} = - {P}_{M}^{′} {g}_{M} . \qquad ( 13 )$$

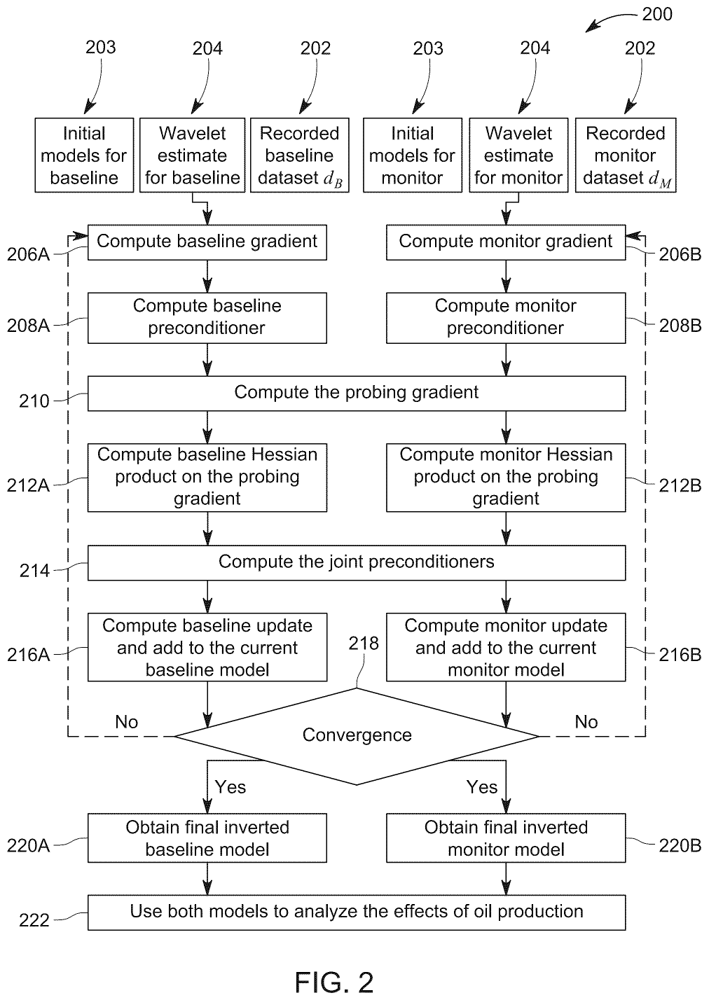

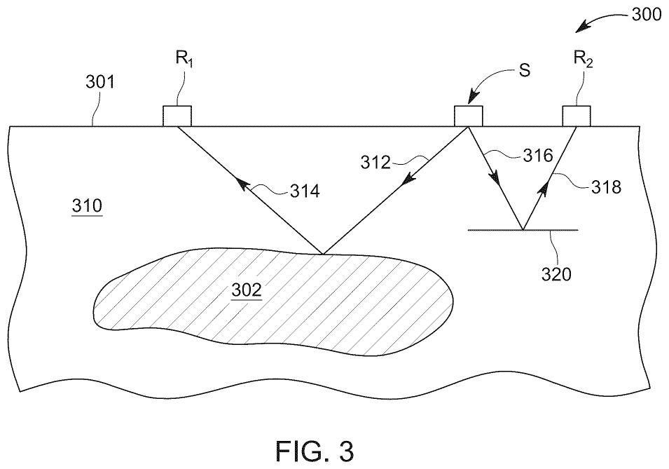

A method for time-lapse FWI based on the joint preconditioners defined by equations (7) is now discussed regarding FIGS. 2 to 4. The method starts in step 202 by receiving seismic data, which includes baseline and monitor datasets d_{B} and d_{M}. In step 203, the initial models m_{B} and m_{M} for the baseline and monitor datasets are selected or calculated, for example, based on the seismic data d_{B} and d_{M}. The baseline and monitor datasets, which are received in step 202, correspond to two different seismic surveys that acquire the seismic data over a same subsurface 310, as illustrated in FIG. 3, but at different times, for monitoring a reservoir or formation 302. FIG. 3 shows a land seismic survey in which a source S emits seismic energy into the subsurface. A wavefield 312 is shown propagating toward the reservoir 302 and then being reflected, and the reflected wavefield 314 is recorded by a corresponding seismic sensor R1. The source S may be any type of seismic source, examples include airgun, pinger, sparker, boomer, marine vibrator, land vibrator, dynamite, etc. The source may be a single source (e.g., single airgun) or an array of sources (e.g., airgun array). The seismic sensor may be one of hydrophones, geophones, particle motion sensors, particle velocity sensors, accelerometers, near-field hydrophones, near-field accelerometers or other sensor configured to detect seismic energy. The data may be from towed streamer, ocean-bottom sensor, OBS, (node or cable) acquisition, land acquisition, transition zone campaign, or borehole (e.g., vertical seismic profile (VSP), distributed acoustic sensing (DAS)).

FIG. 3 further shows another wavefield 316 that is reflected from an interface 320 between layers having different impedances, and the reflected wavefield 318 is recorded by another sensor R2, or by the first sensor R1. The seismic acquisition system 300 is shown in FIG. 3 as being a land system, located on the surface 301 of the earth. However, the system 300 may be a marine system or any other system used in the field. The system 300 may include plural sources S and plural sensors R1, with i taking a value up to tens of thousands.

Returning to the method 200, estimations of both source signatures are received in 204, which are used in steps 206A and 206B to generate synthetic datasets which are compared to the recorded datasets from step 202 through the 4D cost function/to calculate both the baseline gradient g_{B} in step 206A, and the monitor gradient g_{M} in step 206B, through the adjoint state method. The steps labeled with letters A and B in this method may be performed independent of each other. A baseline preconditioner P′_{B} is calculated in step 208A and a monitor preconditioner P′_{M} is calculated in step 208B. These traditional preconditioners can be calculated by using any known method, and they approximate the inverse Hessians. However, as discussed above, these traditional preconditioners do not result in fully solving the inversion problem indicated by equations (5).

In step 210, the method calculates the probing gradient γ, for example, as an average of the independent gradients g_{B} and g from step 206A and B. The baseline Hessian product on the probing gradient H_{B}γ is calculated in step 212A and the monitor Hessian product on the probing gradient H_{M}γ is calculated in step 212B. Then, in step 214, the joint preconditioners P′_{B} and P′_{M} are calculated (based on the conditions set up in equations (7)) to respect the condition of equation (6), i.e., the application of the baseline preconditioner on the baseline Hessian applied to the probing gradient (P′_{B}H_{B}γ) is equal to the application of the monitor preconditioner on the monitor Hessian applied to the probing gradient (P′_{M}H_{M}γ). As shown in equations (7-12), each of the joint preconditioners P′_{B} and P′_{M} is a function of the original preconditioners P′_{B} and P′_{M} and the probing gradient γ, i.e., P′_{B}=ƒ(P_{B}, P_{M},γ), where ƒ is the function.

Having the joint preconditioners P′_{B} and P′_{M}, the method calculates in steps 216A and 216B the baseline model update Δm_{B} and the monitor model update Δm_{M}, based on equations (13), and updates the baseline and monitor models as follows m_{B}^{updated}=m_{B}+Δm_{B} and m_{M}^{updated}=m_{M}+Δm_{M}. The method then estimates in step 218 a convergence criterion, for example, a predetermined number of iterations, or a whether the cost function value is smaller than a pre-determined threshold, etc. If the criterion is not met, the method returns to steps 206A, 206B and the steps discussed above are recalculated, with the updated models m_{B}^{updated} and m_{M}^{updated}. If the criterion is met, the function advances to steps 220A and 220B for calculating the final baseline and monitors models m_{B}^{final} and m_{M}^{final} and these models are used in step 222 to analyze the oil production of a field, etc. In this step, it is possible to use these models to generate an image of the field, to estimate the status of the oil flow and/or deposits.

The term “image” has a broader meaning than a two-dimensional grid of pixel values, being rather a 3-dimensional map of one or more attribute values. The most frequently mapped attribute is seismic wave propagation velocity. The attribute values characterize (and thus allow identification of) different material volumes inside the subsurface and therefore enable estimation of the location and shape of interfaces between different materials. While this profile/image does not provide an accurate location for natural resources such as (but not limited to) oil and/or gas, it enables those trained in the field to determine the presence or absence thereof.

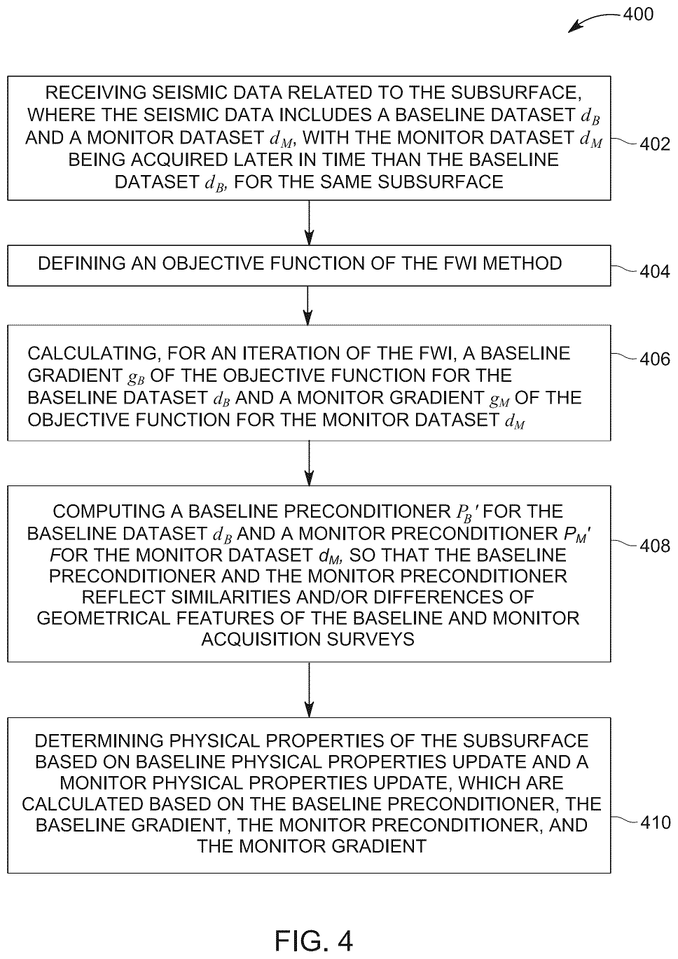

FIG. 4 illustrates a timelapse FWI method 400 for determining physical properties of a subsurface, and optionally, generating an image of the subsurface based on joint preconditioning. The method includes a step 402 of receiving seismic data related to the subsurface, where the seismic data includes a baseline dataset d_{B} and a monitor dataset d_{M}, with the monitor dataset d_{M} being acquired later in time than the baseline dataset d_{B}, for the same subsurface.

The method further includes a step 404 of defining an objective function of the FWI method, a step 406 of calculating, for an iteration of the FWI, a baseline gradient g_{B} of the objective function for the baseline dataset d_{B}, and a monitor gradient g_{M} of the objective function for the monitor dataset d_{M}, a step 408 of computing a baseline preconditioner P′_{B} for the baseline dataset d_{B} and a monitor preconditioner P′_{M} for the monitor dataset d_{M} so that each of the baseline preconditioner P′_{B} and the monitor preconditioner P′_{M} reflects similarities and/or differences of geometrical features of the baseline and monitor acquisition surveys, and a step 410 of determining physical properties of the subsurface based on a baseline physical properties update and a monitor physical properties update, the baseline and monitor physical properties updates being calculated based on the baseline preconditioner P′_{B}, the baseline gradient g_{B}, the monitor preconditioner P′_{M}, and the monitor gradient g_{M}.

The method of FIG. 4 may further include one or more of the following features. For reflecting the similarities and/or differences of the geometrical features of the baseline and monitor acquisition surveys, the baseline and monitor preconditioners satisfy P′_{B}H_{B}γ=P′_{M}H_{M}γ, where H_{B} is a Hessian of a cost function of the FWI for the baseline dataset, H_{M} is a Hessian of the cost function for the monitor dataset, and γ is a probing gradient in a gradient space.

The cost function includes a first term that depends on a baseline model m_{B} for the baseline dataset, a second term that depends on a monitor model m_{M} for the monitor dataset, and a third term that depends on both the baseline and monitor models. The baseline model and the monitor models are velocity models, density models or models of any other physical property of the subsurface associated with wave propagation.

The step of computing may include computing the probing gradient. The method may further include computing a traditional baseline preconditioner and a traditional monitor preconditioner, computing the baseline preconditioner P′_{B} based on the traditional baseline preconditioner, the traditional monitor preconditioner, and the probing gradient, and computing the monitor preconditioner P′_{M} based on the traditional monitor preconditioner, the traditional baseline preconditioner, and the probing gradient.

In one application, the baseline preconditioner P′_{B} and the monitor preconditioner P′_{M} are calculated in a filter space. The filter space is a curvelet space, or a Fourier space, or a wavelet space, and a baseline filter and a monitor filter are applied to calculate the baseline preconditioner P′_{B} and the monitor preconditioner P′_{M}, respectively.

The method may further include calculating a baseline model improvement Δm_{B} of a baseline model m_{B} by applying the baseline preconditioner P′_{B} to the baseline gradient of the cost function of the FWI, and calculating a monitor model improvement Δm_{M} of a monitor model m_{M} by applying the monitor preconditioner P′_{M} to the monitor gradient of the cost function.

The method may also include adding the baseline model improvement to the baseline model to obtain an updated baseline model, which is associated with the baseline physical properties update, adding the monitor model improvement to the monitor model to obtain an updated monitor model, which is associated with the monitor physical properties update, and generating an image of the physical properties based on a difference between the updated baseline model and the updated monitor model after a convergence criteria is met, where the physical properties includes at least one of a velocity or density.

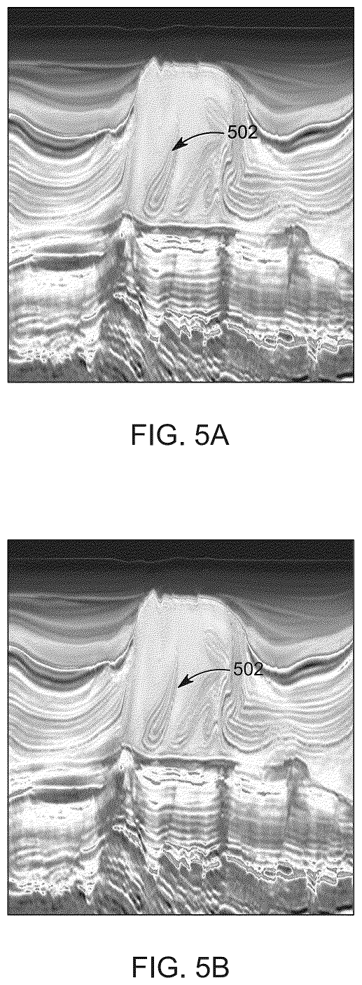

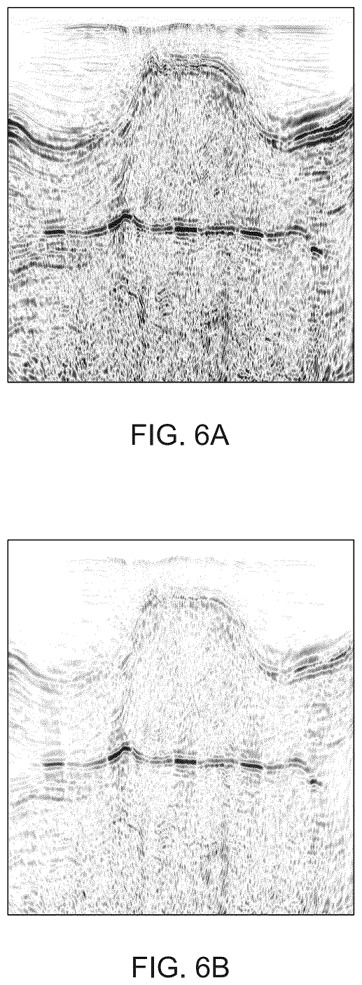

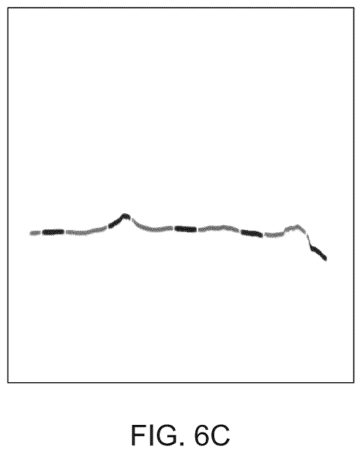

A 2D synthetic example was used to illustrate the difference between the traditional preconditioners and the joint preconditioners introduced in the above embodiments. FIG. 5A illustrates a true baseline velocity model below the base of a salt 502 while FIG. 5B illustrates a true monitor velocity model below the same salt 502. The baseline dataset was obtained using a streamer acquisition and the monitor dataset was obtained using OBN. When the traditional preconditioners were applied to these datasets, the velocity model of FIG. 6A was obtained while when when applying the joint preconditioners P′_{B} and P′_{M}, the velocity model of FIG. 6B was obtained. FIG. 6C illustrates the difference between these two velocity models.

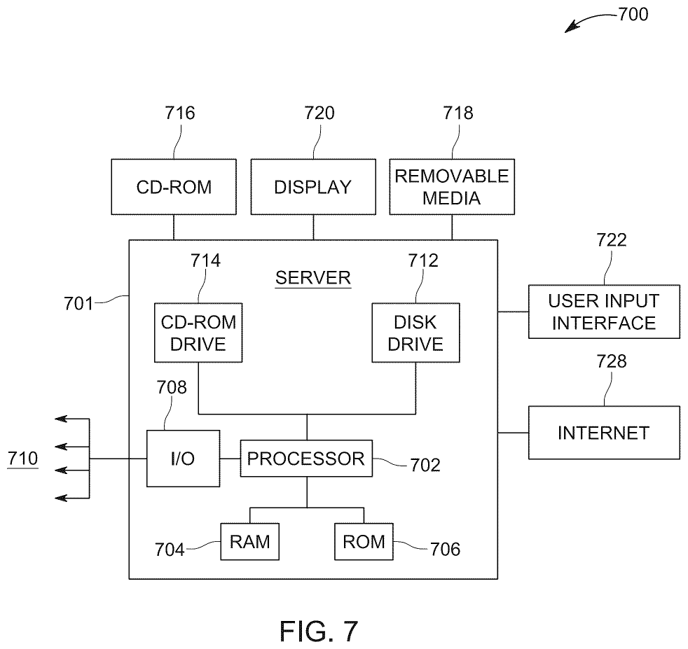

The above-discussed procedures and methods may be implemented in a computing device as illustrated in FIG. 7. Hardware, firmware, software or a combination thereof may be used to perform the various steps and operations described herein. The computing device 700 is suitable for performing the activities described in the above embodiments and may include a server 701. Such a server 701 may include a central processor (CPU) 702 coupled to a random access memory (RAM) 704 and to a read-only memory (ROM) 706. ROM 706 may also be other types of storage media to store programs, such as programmable ROM (PROM), erasable PROM (EPROM), etc. Processor 702 may communicate with other internal and external components through input/output (I/O) circuitry 708 and bussing 710 to provide control signals and the like. Processor 702 carries out a variety of functions as are known in the art, as dictated by software and/or firmware instructions.

Server 701 may also include one or more data storage devices, including hard drives 712, CD-ROM drives 714 and other hardware capable of reading and/or storing information, such as DVD, etc. In one embodiment, software for carrying out the above-discussed steps may be stored and distributed on a CD-ROM or DVD 716, a USB storage device 718 or other form of media capable of portably storing information. These storage media may be inserted into, and read by, devices such as CD-ROM drive 714, disk drive 712, etc. Server 701 may be coupled to a display 720, which may be any type of known display or presentation screen, such as LCD, plasma display, cathode ray tube (CRT), etc. A user input interface 722 is provided, including one or more user interface mechanisms such as a mouse, keyboard, microphone, touchpad, touch screen, voice-recognition system, etc.

Server 701 may be coupled to other devices, such as seismic sources, seismic sensors, or any other data imaging systems. The server may be part of a larger network configuration as in a global area network (GAN) such as the Internet 728, which allows ultimate connection to various landline and/or mobile computing devices.

As described above, the apparatus 700 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 702 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally, or alternatively, the processor may include one or more processors configured in tandem via the bus to enable independent execution of instructions, pipelining and/or multithreading.

In an example embodiment, the processor 702 may be configured to execute instructions stored in the memory device 704 or otherwise accessible to the processor. Alternatively, or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide an FWI method for addressing time-lapse seismic imaging by using joint preconditioners. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Rudrigues, F., Albuquerque, D., Pacheco, G., Oliveira, C., Pereira, K., Huard, B., Cypriano, L., Pereira, R., Khalil, A., U.S. patent application Ser. No. 18/530,452, 2023, System and method for least-squares migration of time-lapse seismic data,
[2] Lailly, P., 1983, The seismic inverse problem as a sequence of before stack migration: Conference on Inverse Scattering: Theory and Application, SIAM, 206-220.
[3] Tarantola, A., 1984, Inversion of seismic reflection data in the acoustic approximation: Geophysics, 49, 1259-1266, doi: 10.1190/1.1441754.
[4] Virieux, J., and S. Operto, 2009, An overview of full-waveform inversion in exploration geophysics: Geophysics, 74, no. 6, WCC1-WCC26, doi: 10.1190/1.3238367.
[5] Sirgue, L., O. I. Barkved, J. P. Van Gestel, O. J. Askim, and J. H. Kommedal, 2009, 3D waveform inversion on Valhall wide-azimuth OBC: 71st Annual International Conference and Exhibition, EAGE, Extended Abstracts, U038.
[6] Lu, R., 2016, Revealing overburden and reservoir complexity with high-resolution FWI: 86th Annual International Meeting, SEG, Expanded Abstracts, 1242-1246, doi.org/10.1190/segam2016-13872562.1.
[7] Shen, X., L. Jiang, J. Dellinger, A. Brenders, C. Kumar, M. James, J. Etgen, D. Meaux, R. Walters, and N. Abdullayev, 2018, High-resolution fullwaveform inversion for structural imaging in exploration: 87th Annual International Meeting, SEG, Expanded Abstracts, 1098-1102, doi.org/10.1190/segam2018-2997202.1.
[8] Greaves, R. J., and T. J. Fulp, 1987, Three-dimensional seismic monitoring of an enhanced oil recovery process: Geophysics, 52, 1175-1187, doi: 10.1190/1.1442381.
[9] Barkved, O., K. Buer, K. Halleland, R. Kjelstadli, T. Kleppan, and T. Kristiansen, 2003, 4D seismic response of primary production and waste injection at the Valhall field: 65th Annual International Conference and Exhibition, EAGE, Extended Abstracts, cp-6, doi: 10.3997/2214-4609-pdb.6.A22.
[10] Wang, M., Huang, S., & Wang, P., 2017, Improved iterative least-squares migration using curvelet-domain Hessian filters. In SEG International Exposition and Annual Meeting (pp. SEG-2017). SEG.
[11] Pevzner, R., M. Urosevic, D. Popik, V. Shulakova, K. Tertyshnikov, E. Caspari, J. Correa, T. Dance, A. Kepic, S. Glubokovskikh, S. Ziramov, B. Gurevich, R. Singh, M. Raab, M. Watson, T. Daley, M. Robertson, and B. Freifeld, 2017, 4D surface seismic tracks small supercritical CO2 injection into the subsurface: CO2CRC Otway project: International Journal of Greenhouse Gas Control, 63, 150-157, doi: 10.1016/j.ijggc 0.2017.05.008.
[12] Plessix, R.-E., S. Michelet, H. Rynja, H. Kuehl, C. Perkins, J. W. de Maag, and P. Hatchell, 2010, Some 3D applications of full waveform inversion: 72nd Conference and Exhibition, EAGE, Workshops and Fieldtrips, Session: WS6 3D Full Waveform Inversion-A Game Changing Technique?
[13] Routh, P., G. Palacharla, I. Chikichev, and S. Lazaratos, 2012, Full wavefield inversion of time-lapse data for improved imaging and reservoir characterization: 82nd Annual International Meeting, SEG, Expanded Abstracts, doi: 10.1190/segam2012-1043.1
[14] Zheng, Y., P. Barton, and S. Singh, 2011, Strategies for elastic full waveform inversion of time-lapse ocean bottom cable (OBC) seismic data: 81st Annual International Meeting, SEG, Expanded Abstracts, 4195-4200, doi: 10.1190/1.3628083.
[15] Hicks, E., H. Hoeber, M. Houbiers, S. P. Lescoffit, A. Ratcliffe, and V. Vinje, 2016, Time-lapse full-waveform inversion as a reservoir-monitoring tool-A North Sea case study: The Leading Edge, 35, 850-858, doi: 10.1190/tle35100850.1
[16] Zhou, W., and D. Lumley, 2021, Central-difference time-lapse 4D seismic full-waveform inversion: Geophysics, 86, no. 2, R161-R172, doi: 10.1190/geo2019-0834.1.
[17] Fu, X., Innanen, K. A., 2023, Stepsize sharing in time-lapse full-waveform inversion. Geophysics, 88 (2): M59-M70. doi.org/10.1190/geo2022-0094.1.
[18] Plessix, R. E. A review of the adjoint-state method for computing the gradient of a functional with geophysical applications. Geophysical Journal International, 167(2), 495-503.
[19] Métivier, L., Brossier, R., Operto, S., Virieux, J., 2012, Second-order adjoint state methods for Full Waveform Inversion. EAGE 2012-74th European Association of Geoscientists and Engineers Conference and Exhibition, Copenhagen, Denmark.
[20] Pica, A., Diet, J. P., and Tarantola, A., (1990), “Nonlinear inversion of seismic reflection data in a laterally invariant medium,” GEOPHYSICS 55: 284-292.
[21] Candès, E., L. Demanet, D. Donoho, and L. Ying, 2006, Fast Discrete Curvelet Transforms: Multiscale Modeling & Simulation, 5, 861-899.

What is claimed is:

1. A joint timelapse full waveform inversion (FWI) method for estimating physical properties of a subsurface, the method comprising:
receiving seismic data related to the subsurface, wherein the seismic data includes a baseline dataset d_{B} and a monitor dataset d_{M}, with the monitor dataset d_{M} being acquired later in time than the baseline dataset d_{B}, for the same subsurface;
defining an objective function of the FWI method;
calculating, for an iteration of the FWI, a baseline gradient g_{B} of the objective function for the baseline dataset d_{B}, and a monitor gradient g_{M} of the objective function for the monitor dataset d_{M};
computing a baseline preconditioner P′_{M} for the baseline dataset d_{B} and a monitor preconditioner P′_{B} for the monitor dataset d_{M} so that each of the baseline preconditioner P′_{B} and the monitor preconditioner P′_{M} reflects similarities and/or differences of geometrical features of the baseline and monitor acquisition surveys; and
determining physical properties of the subsurface based on a baseline physical properties update and a monitor physical properties update, the baseline and monitor physical properties updates being calculated based on the baseline preconditioner P′_{B}, the baseline gradient g_{B}, the monitor preconditioner P′_{M}, and the monitor gradient g_{M}.

2. The method of claim 1, wherein, for reflecting the similarities and/or differences of the geometrical features of the baseline and monitor acquisition surveys, the baseline and monitor preconditioners satisfy P′_{B}H_{B}γ=P′_{M}H_{M}γ, where H_{B} is a Hessian of a cost function of the FWI for the baseline dataset, H_{M} is a Hessian of the cost function for the monitor dataset, and γ is a probing gradient in a gradient space.

3. The method of claim 2, wherein the cost function includes a first term that depends on a baseline model m_{B} for the baseline dataset, a second term that depends on a monitor model m_{M} for the monitor dataset, and a third term that depends on both the baseline and monitor models.

4. The method of claim 3, wherein the baseline model and the monitor models are velocity models, density models or models of any other physical property of the subsurface associated with wave propagation.

5. The method of claim 1, wherein the step of computing comprises:
computing the probing gradient.

6. The method of claim 5, further comprising:
computing a traditional baseline preconditioner and a traditional monitor preconditioner;
computing the baseline preconditioner P′_{B} based on the traditional baseline preconditioner, the traditional monitor preconditioner, and the probing gradient; and
computing the monitor preconditioner P′_{M} based on the traditional monitor preconditioner, the traditional baseline preconditioner, and the probing gradient.

7. The method of claim 1, wherein the baseline preconditioner P′_{B} and the monitor preconditioner P′_{M} are calculated in a filter space.

8. The method of claim 7, wherein the filter space is a curvelet space, or a Fourier space, or a wavelet space, and a baseline filter and a monitor filter are applied to calculate the baseline preconditioner P′_{B} and the monitor preconditioner P′_{M}, respectively.

9. The method of claim 1, further comprising:
calculating a baseline model improvement Δm_{B} of a baseline model m_{B} by applying the baseline preconditioner P′_{B} to the baseline gradient of the cost function of the FWI; and
calculating a monitor model improvement Δm_{M} of a monitor model m_{M} by applying the monitor preconditioner P′_{M} to the monitor gradient of the cost function.

10. The method of claim 9, further comprising:
adding the baseline model improvement to the baseline model to obtain an updated baseline model;
adding the monitor model improvement to the monitor model to obtain an updated monitor model; and
generating an image of the physical properties based on a difference between the updated baseline model and the updated monitor model after a convergence criteria is met, wherein the physical properties includes at least one of a velocity or density.

11. A computing device for joint preconditioning timelapse full waveform inversion (FWI) for generating an image of a subsurface, the computing device comprising:
an interface for receiving seismic data related to the subsurface, wherein the seismic data includes a baseline dataset d_{B} and a monitor dataset d_{M}, with the monitor dataset d_{M} being acquired later in time than the baseline dataset d_{B}, for the same subsurface; and
a processor connected to the interface and configured to,
define an objective function of the FWI method;
calculate, for an iteration of the FWI, a baseline gradient g_{B} of the objective function for the baseline dataset d_{B}, and a monitor gradient g_{M} of the objective function for the monitor dataset d_{M};
compute a baseline preconditioner P′_{B} for the baseline dataset d_{B} and a monitor preconditioner P′_{M} for the monitor dataset d_{M} so that each of the baseline preconditioner P′_{B} and the monitor preconditioner P′_{M} reflects similarities and/or differences of geometrical features of the baseline and monitor acquisition surveys; and
determining physical properties of the subsurface based on a baseline physical properties update and a monitor physical properties update, the baseline and monitor physical properties updates being calculated based on the baseline preconditioner P′_{B}, the baseline gradient g_{B}, the monitor preconditioner P′_{M}, and the monitor gradient g_{M}.

12. The device of claim 11, wherein, for reflecting the similarities and/or differences of the geometrical features of the baseline and monitor acquisition surveys, the baseline and monitor preconditioners satisfy P′_{B}H_{B}γ=P′_{M}H_{M}γ, where H_{B} is a Hessian of a cost function of the FWI for the baseline dataset, H_{M} is a Hessian of the cost function for the monitor dataset, and γ is a probing gradient in a gradient space.

13. The device of claim 12, wherein the cost function includes a first term that depends on a baseline model m_{B} for the baseline dataset, a second term that depends on a monitor model m_{M} for the monitor dataset, and a third term that depends on both the baseline and monitor models.

14. The device of claim 13, wherein the baseline model and the monitor models are velocity models, density models or models of any other physical property of the subsurface associated with wave propagation.

15. The device of claim 11, wherein the processor is further configured to:
compute the probing gradient.

16. The device of claim 15, wherein the processor is further configured to:
compute a traditional baseline preconditioner and a traditional monitor preconditioner;
compute the baseline preconditioner P′_{B} based on the traditional baseline preconditioner, the traditional monitor preconditioner, and the probing gradient; and
compute the monitor preconditioner P′_{M} based on the traditional monitor preconditioner, the traditional baseline preconditioner, and the probing gradient.

17. The device of claim 11, wherein the baseline preconditioner P′_{B} and the monitor preconditioner P′_{M} are calculated in a filter space and the filter space is a curvelet space, or a Fourier space, or a wavelet space, and a baseline filter and a monitor filter are applied to calculate the baseline preconditioner P′_{B} and the monitor preconditioner P′_{M}, respectively.

18. The device of claim 11, wherein the processor is further configured to:
calculate a baseline model improvement Δm_{B} of a baseline model m_{B} by applying the baseline preconditioner P′_{B} to the baseline gradient of the cost function of the FWI; and
calculate a monitor model improvement Δm_{M} of a monitor model m_{M} by applying the monitor preconditioner P′_{M} to the monitor gradient of the cost function.

19. The device of claim 18, wherein the processor is further configured to:
add the baseline model improvement to the baseline model to obtain an updated baseline model;
add the monitor model improvement to the monitor model to obtain an updated monitor model; and
generate an image of the physical properties based on a difference between the updated baseline model and the updated monitor model after a convergence criteria is met, wherein the physical properties includes at least one of a velocity or density.

20. A non-transitory computer readable medium including computer executable instructions, wherein the instructions, when executed by a processor, implement a method for joint preconditioning timelapse full waveform inversion (FWI) for generating an image of a subsurface, the medium comprising instructions for:
receiving seismic data related to the subsurface, wherein the seismic data includes a baseline dataset d_{B} and a monitor dataset d_{M}, with the monitor dataset d_{M} being acquired later in time than the baseline dataset d_{B}, for the same subsurface;
defining an objective function of the FWI method;
calculating, for an iteration of the FWI, a baseline gradient g_{B} of the objective function for the baseline dataset d_{B}, and a monitor gradient g_{M} of the objective function for the monitor dataset d_{M};
computing a baseline preconditioner P′_{B} for the baseline dataset dg and a monitor preconditioner P′_{M} for the monitor dataset d_{M} so that each of the baseline preconditioner P′_{B}, and the monitor preconditioner P′_{M} reflects similarities and/or differences of geometrical features of the baseline and monitor acquisition surveys; and
determining physical properties of the subsurface based on a baseline physical properties update and a monitor physical properties update, the baseline and monitor physical properties updates being calculated based on the baseline preconditioner P′_{B}, the baseline gradient g_{B}, the monitor preconditioner P′_{M}, and the monitor gradient g_{M}.
